(19) United States
(12) Patent Application Publication
(10) Pub. No.: US 2023/0409209 A1
(43) Pub. Date: Dec. 21, 2023

(54) INFORMATION PROCESSING APPARATUS, INFORMATION PROCESSING METHOD, AND STORAGE MEDIUM

(71) Applicant: BUFFALO INC., Nagoya-shi (JP)

(72) Inventors: Yoshitaka KATO, Aichi (JP); Suguru ISHII, Aichi (JP); Takahito ONO, Aichi (JP); Masahiko HORIBE, Aichi (JP)

(73) Assignee: BUFFALO INC., Nagoya-shi (JP)

(21) Appl. No.: 18/337,441

(22) Filed: Jun. 20, 2023

(30) Foreign Application Priority Data
Jun. 21, 2022 (JP) 2022-099862

(51) Int. Cl. G06F 3/06

(52) U.S. Cl. CPC G06F 3/0619; G06F 3/065; G06F 3/0673

(57) ABSTRACT

An information processing apparatus that is connected to a storage device that stores a file includes processing circuitry. The processing circuitry is configured to receive an instruction of an end process during execution of a predetermined process related to the file, determine, after the predetermined process is completed, whether the instruction of the end process was received during the execution of the predetermined process, and execute the end process after it is determined that the instruction of the end process was received.

### CROSS-REFERENCE TO RELATED APPLICATION

This application is based on and claims priority under 35 USC 119 from Japanese Patent Application No. 2022-099862 filed on Jun. 21, 2022, the entire content of which is incorporated herein by reference.

### TECHNICAL FIELD

The present disclosure relates to an information processing apparatus, an information processing method, and a storage medium.

### BACKGROUND

In recent years, it is necessary to perform a mount process in a system when a storage device such as a hard disc drive (HDD) or a solid state drive (SSD) connected to a computer device is used. Further, it is necessary to perform an unmount process before removal of the storage device.

JP2015-35144A discloses an information storage system in which a mount operation is performed during a read operation, and an unmount operation is performed when the read operation is completed.

When a storage device is being used or when the storage device is in a busy state, execution of the unmount process or the like may be restricted. For example, when it takes time to write or read a data file to and from the storage device, a user needs to wait until the process is completed, and after that the user has to instruct execution of the above restricted process (for example, unmount process of the storage device).

In an information processing apparatus in the related art, it is necessary to determine a timing to instruct execution of a restricted process, and thus operations such as removal of a storage device are complicated.

The present disclosure is made in view of the above matters, and an object of the present disclosure is to provide an information processing apparatus, an information processing method, and a storage medium storing a program for simplifying an instruction of a process whose execution is restricted while a storage device is busy due to an operation such as a removal operation of the storage device.

### SUMMARY

Aspect of the present disclosure relates to an information processing apparatus that is connected to a storage device that stores a file, the information processing apparatus including: processing circuitry, wherein the processing circuitry receives an instruction of an end process during execution of a predetermined process related to the file, determines, after the predetermined processing is completed, whether the instruction of the end process was received during the execution of the predetermined process, and executes the end process after it is determined that the instruction of the end process was received.

Another aspect the present disclosure relates to an information processing method including: receiving, by an information processing apparatus that is connected to a storage device that stores a file, an instruction of an end process during execution of a predetermined process related to the file, determining, by the information processing apparatus, whether the instruction of the end process was received during the execution of the predetermined process after the predetermined processing is completed, and executing, by the information processing apparatus, the end process after it is determined that the instruction of the end process was received.

Another aspect of the present disclosure relates to a non-transitory computer-readable storage medium storing a program to cause an information processing apparatus that is connected to a storage device that stores a file to execute a process, the process including: receiving an instruction of an end process during execution of a predetermined process related to the file, determining, after the predetermined processing is completed, whether the instruction of the end process was received during the execution of the predetermined process, and executing the end process after it is determined that the instruction of the end process was received.

### BRIEF DESCRIPTION OF DRAWINGS

Exemplary embodiment(s) of the present invention will be described in detail based on the following figures, wherein:

FIG. 1 is a block diagram showing a configuration example of an information processing apparatus according to an embodiment of the present disclosure;

FIG. 2 is a functional block diagram showing an example of the information processing apparatus according to the embodiment of the present disclosure;

FIG. 3 is a schematic diagram showing an example of an interface displayed by the information processing apparatus according to the embodiment of the present disclosure;

FIG. 4 is a block diagram showing a hardware configuration of the information processing apparatus according to the embodiment of the present disclosure; and

FIG. 5 is a flowchart showing an operation example of the information processing apparatus according to the embodiment of the present disclosure.

### DESCRIPTION OF EMBODIMENTS

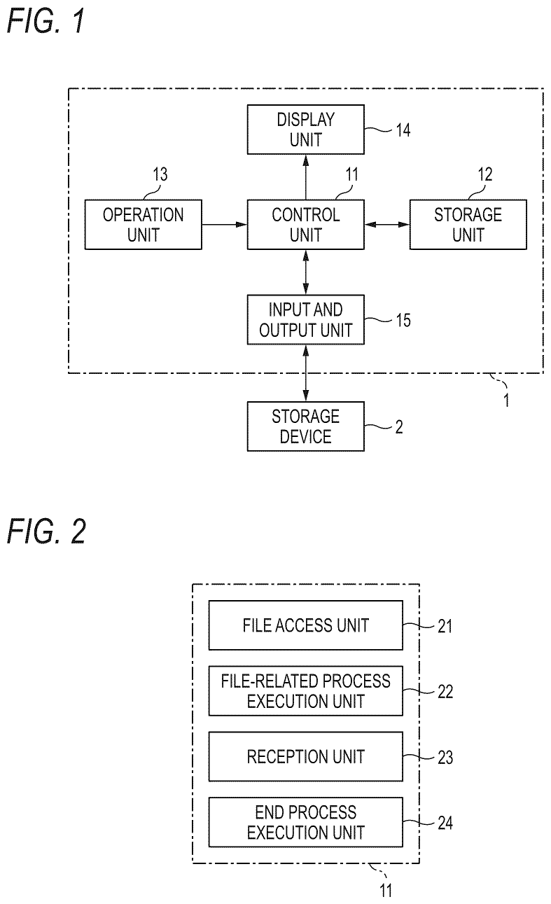

An embodiment of the present disclosure will be described with reference to the drawings. An information processing apparatus 1 according to the embodiment of the present disclosure is a computer device such as a personal computer, and as shown in FIG. 1, basically includes a control unit 11, a storage unit 12, an operation unit 13, a display unit 14, and an input and output unit 15. The information processing apparatus 1 is connected to a storage device 2 via the input and output unit 15.

The control unit 11 is a circuit such as a central processing unit (CPU) that performs signal processing, and operates according to a program stored in the storage unit 12. In the present embodiment, the control unit 11 performs operations of a general operating system (for example, Windows (registered trademark) OS), and executes various file-related processes (a predetermined process in the present disclosure), such as reading and writing of a file (data file) into and from the storage device 2, under management of the operating system. The control unit 11 may be implemented by processing circuitry such as a field-programmable gate array (FPGA) or a digital signal processor (DSP). The control unit 11 may further be implemented by combining a plurality of digital circuits.

In the present embodiment, the control unit 11 further receives an instruction of an end process during execution of the predetermined file-related process. When the execution of the predetermined file-related process is completed, the control unit 11 determines whether the instruction of an end process was received during the execution of the predetermined process, and, in a case where the instruction was received, executes the instructed end process. Detailed operation of the control unit 11 will be described later.

The storage unit 12 includes storage sections such as a memory, an HDD or SSD, and stores a program executed by the control unit 11. The storage unit 12 also operates as a work memory of the control unit 11. Here, the program stored in the storage unit 12 may be stored and provided in a computer-readable and non-transitory recording medium, and be copied and stored in the storage unit 12.

The operation unit 13 includes a keyboard, a mouse and the like. The operation unit 13 receives a user instruction operation and outputs information indicating contents thereof to the control unit 11. The display unit 14 is a display controller or the like connected to a display device (not shown), and displays and outputs information on the display device in accordance with an instruction received from the control unit 11.

The input and output unit 15 includes a universal serial bus (USB) interface, a network interface and the like. The input and output unit 15 is connected to, for example, the storage device 2. The input and output unit 15 reads a file from the storage device 2 in accordance with an instruction received from the control unit 11, and outputs the file to the control unit 11. The input and output unit 15 further executes a process of writing a file to the storage device 2 in accordance with an instruction received from the control unit 11.

The storage device 2 is a storage device such as an HDD or SSD. The storage device 2 is connected to the information processing apparatus 1, is written with a file received from the information processing apparatus 1, and is read to output a file requested by the information processing apparatus 1.

Next, an example of a processing performed by the control unit 11 of the information processing apparatus 1 will be described. The control unit 11 in the present embodiment functionally implements a configuration including a file access unit 21, a file-related process execution unit 22, a reception unit 23, and an end process execution unit 24, as shown in FIG. 2, by executing a program stored in the storage unit 12.

The file access unit 21 may hook a procedure for opening a file (file open) and a procedure for closing the file (file close) by the operating system, and execute the predetermined process when these procedures are called.

In an example of the present embodiment, when the procedure for opening a file is called (that is, in response to an instruction to open the file), the file access unit 21 sets information indicating that the storage device 2 is being used in association with information specifying the storage device 2 that stores (or is storing) the file to be opened. The information is, for example, an integer value representing the number of processes of opening the file, and the file access unit 21 may set the information indicating that the storage device 2 is being used by incrementing the value by “one”. The file access unit 21 then executes the procedure for opening the file of the operating system, outputs information specifying the opened file to the file-related process execution unit 22, and notifies the reception unit 23 of a start of the process.

Further, when the procedure for closing the file is called (that is, in response to an instruction to close the file), the file access unit 21 decrements the integer value by “one” in association with the information specifying the storage device 2 that stores (or is storing) the file to be closed, and notifies the reception unit 23 of an end of the process.

The file-related process execution unit 22 is an application program for executing the predetermined file-related process. The file-related process execution unit 22 is, for example, an application program for copying a file. The file-related process execution unit 22 instructs the file access unit 21 to open a copy source file that is instructed by a user, and instructs the file access unit 21 to open a new file in a directory that is indicated by the user as a copy destination. The file-related process execution unit 22 then writes contents of the copy source file into the copy destination file. When this process is completed, the file-related process execution unit 22 instructs the file access unit 21 to close both the copy source file and the copy destination file, and ends the process.

The above description is an example, and the file-related process execution unit 22 may be, in addition to the application program for copying a file, an application program for executing processes such as reading a file, writing to a file, deleting a file, or moving a file (a process of copying and a process of deleting a copy source).

The reception unit 23 receives a notification of a start of a process from the file access unit 21. After receiving the notification, that is, at a timing when a predetermined reception condition is satisfied after the file-related process execution unit 22 starts the process, the reception unit 23 performs a display, on the display unit 14, that an instruction of an end process is able to be received.

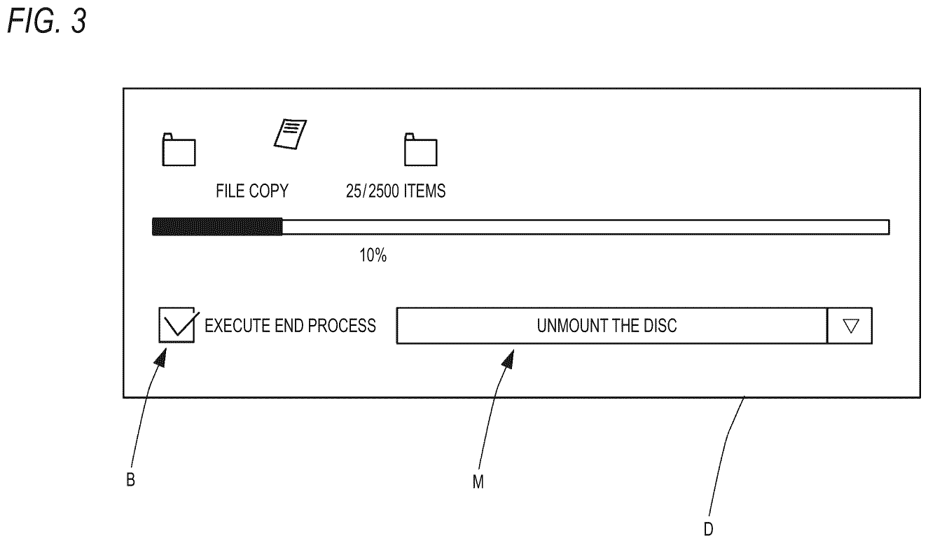

The display may be performed by displaying, in a dialog (D) including a progress bar displaying a progress of file movement or the like, a check box (B) for inputting the instruction of execution of the end process and a menu (M) for selecting contents of a specific process, as shown in FIG. 3, for example.

When receiving the instruction of the end process input by the user while the file-related process execution unit 22 is performing a process, that is, before being notified of an end of the process by the file access unit 21 (in a state in which the reception condition is satisfied), the reception unit 23 receives the input instruction (the instruction of the end process) and holds contents of the instruction in the storage unit 12.

In response to being notified of the end of the process by the file access unit 21, the reception unit 23 checks whether the instruction of the end process is held in the storage unit 12 (that is, checks whether the instruction of the end process was received), and, in a case where the instruction of the end process is held, causes the end process execution unit 24 to execute the end process in accordance with the held instruction.

When receiving the instruction to execute the end process from the reception unit 23, the end process execution unit 24 executes the end process in accordance with the instruction. In an example of the present embodiment, the instruction of the end process received by the reception unit 23 is an instruction to unmount (disconnect) the storage device 2. In this case, the end process execution unit 24 attempts to unmount the storage device 2. When no other process is performed on the file stored in the storage device 2, the storage device 2 is unmounted. When the storage device 2 is busy, such as when another process is being performed on the file stored in the storage device 2, the end process execution unit 24 fails to perform the unmount process. In this case, the end process execution unit 24 may make a notification of an error and then end the process. Alternatively, the end process execution unit 24 may wait for predetermined time period and then retry the end process. In other words, the end process execution unit 24 may execute the instructed end process, the unmount process in this case, again.

In a case where the unmount process fails even when the unmount process was retried, the end process execution unit 24 may make a notification of an error and then end the process or further retry the end process repeatedly. Even in case of retrying the end process repeatedly, the end process execution unit 24 may make a notification of an error and end the process when the unmount process fails after being retried a predetermined number of times (one or more).

Examples of the end process include not only disconnecting the storage device described above, but also a request for an authentication operation (process of requesting an input of a predetermined password and accepting no other operation until the password is input, such as logoff), a request for stopping network communication (process of bringing down one of network interfaces), a shutdown process (process of power shutdown of the information processing apparatus 1), or any combination thereof.

(Operation)

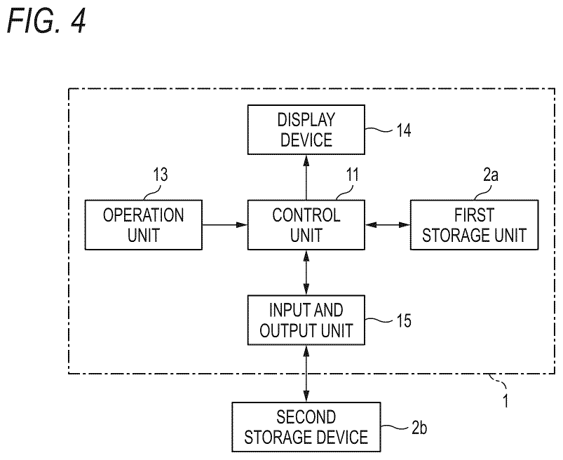

The information processing apparatus 1 according to the present embodiment has the above-described basic configuration, and operates as follows. In the following example of the present embodiment, a first storage device 2a is connected as a built-in storage device to the information processing apparatus 1, and a second storage device 2b is connected as an attachable and detachable external storage device separately from the information processing apparatus 1 via the input and output unit 15, as shown in FIG. 4.

The first storage device 2a stores an operating system and an application program. The first storage device 2a may also store user data. It is assumed that the second storage device 2b stores the user data.

The information processing apparatus 1 receives from the user an instruction to copy a plurality of files that are the user data stored in the first storage device 2a to the second storage device 2b and operates as follows.

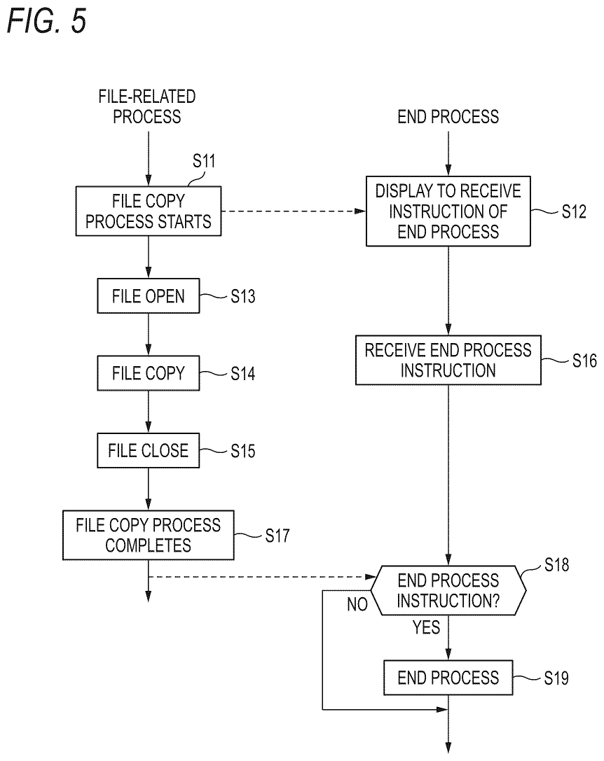

As shown in FIG. 5, the control unit 11 of the information processing apparatus 1 executes a copy process for each file to be copied as a file-related process. In parallel with the file-related process, the control unit 11 further executes a process related to an end process asynchronously. That is, when the file-related process is started (S11) and while a predetermined reception condition is satisfied (here, for example, during execution of the file-related process soon after a start thereof), the control unit 11 performs a display on the display unit 14 that an instruction of an end process is able to be received (S12).

Here, as shown in the example of FIG. 3, the check box (B) for inputting the instruction of execution of the end process and the menu (M) for selecting contents of the specific process are displayed in the dialog (D) including the progress bar displaying the progress of file movement or the like.

The control unit 11 calls a program (API: application programming interface) provided by the operating system, and opens an instructed file that is a copy source. At the same time, a new file is opened in a directory in the second storage device 2b that is a copy destination designated by the user (S13).

The control unit 11 then executes a process of writing contents of the copy source file into the copy destination file (S14). When the copying of one file is completed, the control unit 11 calls the API of the operating system to close the copy source file and the copy destination file created in the directory in the second storage device 2b (S15). The control unit 11 repeats the process of steps S13 to S15 for each file.

On the other hand, while the control unit 11 repetes the process of steps S13 to S15 as the file-related process, in response to the check box being checked and “remove the disc when completed” being selected from the menu in the dialog displayed in step S12, the information processing apparatus 1 holds the contents of the end process instruction received from the user in the storage unit 12 (S16).

After copying all the files and repeating of the process of steps S13 to S15 completes (S17), the control unit 11 checks whether the instruction of the end process is held (S18). Here, since the instruction of the end process is held (S18: Yes), the control unit 11 starts and performs the end process in accordance with the held instruction (S19). Here, since “removal of the disc” is instructed in step S16, the control unit 11 attempts to unmount the second storage device 2b and ends the process. In a case where the instruction of the end process is not held (S18: No), for example, in a case where the user did not input the instruction in step S16, the control unit 11 ends the process.

The control unit 11 deletes contents of the instructed end process held in the storage unit 12 when an instruction of a process is canceled, such as when the user unchecks the check box that was once checked by the user in the dialog displayed in step S12, before the repeated process of steps S13 to S15 is completed. In this case, it is determined that the instruction of the end process is not held (S18: No), and no end process would be performed.

Further, when the user changes the selection after once selecting the menu in the dialog displayed in step S12, the control unit 11 overwrites contents of the instructed end process held in the storage unit 12 with the contents of newly selected process and holds the contents of the newly selected process. In this example, the held instruction is replaced with the instruction of the newly selected process, and thus the newly selected process is executed in step S19.

(Reception Condition)

A condition (reception condition) for receiving an instruction of an end process by the information processing apparatus 1 may be whether the file-related process is being executed as in the above example, or may be following conditions.

That is, in an example of the present embodiment, the reception condition may be whether it is in a period from ts seconds after a start of a process to a point at which expected time to an end of the process is te seconds or more. Here, when parameters ts=te=0, the period satisfying the reception condition is equal to “during execution of the file-related process”, and when the parameter ts>0 is set (for example, ts=10), the instruction of the end process is received only when certain time is necessary for the file-related process. Calculation of the expected time until the end of the process can adopt a widely known method using information on throughput, and thus detailed description thereof will be omitted here.

Further, the reception condition may be a condition related to a file to be processed. For example, the reception condition may be whether a file to be processed is present in the storage device 2 connected to the information processing apparatus 1 via the input and output unit 15. Under this condition, when the file-related process is accompanied by reading the file from the external storage device 2 or writing the file to the external storage device 2, the instruction of the end process is received.

The reception condition may be, for example, whether the number of files to be processed exceeds a predetermined threshold value. In this case, the instruction of the end process is received when the number of files to be processed is larger than a predetermined number.

The reception condition may be a combination of the above-described conditions. For example, the information processing apparatus 1 may set, as the reception condition, a condition that the number of files to be processed exceeds a predetermined number and ts seconds elapses after the start of the process.

(Modifications)

In the above description, a procedure for opening a file (file open) and a procedure for closing a file (file close) by the operating system are hooked when the control unit 11 functions as the file access unit 21, and the present embodiment is not limited thereto.

As another example, the file access unit 21 may function integrally with the file-related process execution unit 22 and notify the reception unit 23 of a start of the file-related process when a file is opened in a process as the file-related process execution unit 22.

Further, the file access unit 21 in this example notifies the reception unit 23 of an end of the process when the file is closed in the process as the file-related process execution unit 22.

According to this example, processes according to the present embodiment may be implemented without being hooked to a process of the operating system.

As described above, the following matters are disclosed in the present specification.

An aspect of the present disclosure relates to an information processing apparatus that is connected to a storage device that stores a file, the information processing apparatus including: processing circuitry, wherein the processing circuitry receives an instruction of an end process during execution of a predetermined process related to the file, determines, when the predetermined processing is completed, whether the instruction of the end process was received during the execution of the predetermined process, and executes the end process when the instruction of the end process was received.

In this manner, the end process may be performed at a freely selected timing, and an instruction of a process that is restricted from being executed while the storage device is busy, such as a removal operation of the storage device, may be simplified.

The end process may include disconnection of the storage device. In this case, the removal operation of the storage device may be simplified.

Further, the processing circuitry may execute the end process again when the end process fails. Accordingly, even when the disconnection process is restricted by, for example, a process other than the predetermined process executed when the instruction of the end process is received, the disconnection process may be continued and the removal operation of the storage device of the user may be simplified. When the end process is executed again and the end process fails a predetermined number of times, the processing circuitry may end the process with notification of the failure.

The end process may further include at least one of a process of requesting an authentication operation, a process of stopping network communication, or a shutdown process. In this manner, various types of end process may be simply instructed.

The predetermined process may include at least one of moving the file or copying the file. The processing circuitry may perform a display that the instruction of the end process is receivable in response to a predetermined condition being satisfied. For example, the processing circuitry may perform the display that the instruction of the end process is receivable in a period after receiving notification of a start of the predetermined process until receiving notification of an end of the predetermined processing.

Another aspect the present disclosure relates to an information processing method including: receiving, by an information processing apparatus that is connected to a storage device that stores a file, an instruction of an end process during execution of a predetermined process related to the file, determining, by the information processing apparatus, whether the instruction of the end process was received during the execution of the predetermined process when the predetermined processing is completed, and executing, by the information processing apparatus, the end process when the instruction of the end process was received.

Another aspect of the present disclosure relates to a non-transitory computer-readable storage medium storing a program to cause an information processing apparatus that is connected to a storage device that stores a file to execute a process, the process including: receiving an instruction of an end process during execution of a predetermined process related to the file, determining, when the predetermined processing is completed, whether the instruction of the end process was received during the execution of the predetermined process, and executing the end process when the instruction of the end process was received.

According to these aspects of the present disclosure, the end process may be performed at a freely selected timing, and an instruction of a process that is restricted from being executed while the storage device is busy, such as a removal operation of the storage device, may be simplified.

What is claimed is:

1. An information processing apparatus that is connected to a storage device that stores a file, the information processing apparatus comprising:
processing circuitry, wherein
the processing circuitry is configured to
receive an instruction of an end process during execution of a predetermined process related to the file,
determine, after the predetermined process is completed, whether the instruction of the end process was received during the execution of the predetermined process, and
execute the end process after it is determined that the instruction of the end process was received.

2. The information processing apparatus according to claim 1, wherein
the end process includes disconnection of the storage device.

3. The information processing apparatus according to claim 1, wherein
the processing circuitry is further configured to retry to execute the end process again after the end process fails.

4. The information processing apparatus according to claim 3, wherein
after the end process is retried to be executed again and the retried end process fails a predetermined number of times, the processing circuitry is further configured to end the end process with notification of the failure.

5. The information processing apparatus according to claim 2, wherein
the end process further includes at least one of a process of requesting an authentication operation, a process of stopping network communication, and a shutdown process.

6. The information processing apparatus according to claim 1, wherein
the predetermined process includes at least one of moving the file and copying the file.

7. The information processing apparatus according to claim 1, wherein
the processing circuitry is further configured to perform a display that the instruction of the end process is receivable in response to a predetermined condition being satisfied.

8. The information processing apparatus according to claim 7, wherein
the processing circuitry is further configured to perform the display that the instruction of the end process is receivable in a period after receiving notification of a start of the predetermined process until receiving notification of an end of the predetermined process.

9. An information processing method comprising:
receiving, by an information processing apparatus that is connected to a storage device that stores a file, an instruction of an end process during execution of a predetermined process related to the file,
determining, by the information processing apparatus, whether the instruction of the end process was received during the execution of the predetermined process, after the predetermined processing is completed, and
executing, by the information processing apparatus, the end process after it is determined that the instruction of the end process was received.

10. The information processing method according to claim 9, wherein
the end process includes disconnection of the storage device.

11. The information processing method according to claim 9, further comprising:
performing, by the information processing apparatus, a display that the instruction of the end process is receivable in response to a predetermined condition being satisfied.

12. A non-transitory computer-readable storage medium storing a program to cause an information processing apparatus, that is connected to a storage device that stores a file, to execute a process, the process comprising:
receiving an instruction of an end process during execution of a predetermined process related to the file,
determining, after the predetermined processing is completed, whether the instruction of the end process was received during the execution of the predetermined process, and
executing the end process after it is determined that the instruction of the end process was received.

13. The non-transitory computer-readable storage medium according to claim 12, wherein
the end process includes disconnection of the storage device.

14. The non-transitory computer-readable storage medium according to claim 12, the processing further comprising:
performing, by the information processing apparatus, a display that the instruction of the end process is receivable in response to a predetermined condition being satisfied.
